(19) United States
(12) Patent Application Publication
(10) Pub. No.: US 2001/0056550 A1
(43) Pub. Date: Dec. 27, 2001

(54) Protective device for internal resource protection in network and method for operating the same

(75) Inventor: Sang-Woo Lee, Incheon (KR)

Correspondence Address: FLESHNER & KIM, LLP, P.O. Box 221200, Chantilly, VA, 20153-1200, US

(73) Assignee: LG Electronics Inc.

(21) Appl. No.: 09/891,300

(22) Filed: Jun. 27, 2001

(30) Foreign Application Priority Data
Jun. 27, 2000 (KR) 35533/2000

(51) Int. Cl. G06F 11/30

(52) U.S. Cl. 713/201; 713/153

(57) ABSTRACT

A protective device for an internal resource protection in a network and method for operating the same is disclosed. The method preferably includes giving an internal user of a local network (internal network) in which a firewall is built a proper ID and host, performing authentication and access control for a request for accessing to an external network from the internal user, and if an access to the external network is permitted, connecting to a server of the external network, receiving a service command from the user, and if the received service command is a command for requesting data transmission, transmitting file data transmitted from the user to the server, storing copies of the transmitted file data and log information, and transmitting the log information to an operator. Accordingly, a network operator can monitor and trace the transmission and reception of FTP service from an internal network to an external network.

### BACKGROUND OF THE INVENTION

1. Field of the Invention

The present invention relates to a network system, and more particularly, to a protective device for an internal resource protection in a network and method for operating the same.

2. Background of the Related Art

When configuring a local network that is to be connected to a public network such as the internet, resources that are freely shared in the local network (the “internal network”) need to be prevented from flowing into the external public network.

To achieve this, a protective function for a network resource is typically implemented by a firewall. When an important resource needs to be prevented from flowing to the outside network, the firewall requires a high degree of reliability.

FIG. 1 is a block diagram showing a typical implementation of a protective device in a network. As illustrated in FIG. 1, the protective device includes a firewall 1 for receiving a connection request from an external network to an internal network and selectively performing a disconnection function, a FTP server for performing a File Transfer Protocol (FTP) service upon receipt of the connection request, and a plurality of clients 2 located in the external network for connecting to a FTP server located in the internal network upon receipt of the authentication of the firewall 1.

The firewall 1 of the internal network is configured to provide the FTP service to an external network. It is provided with a FTP proxy for determining whether or not the requesting client 2 of the external network is authenticated and therefore authorized to connect to the internal network.

In other words, when the client 2 located in the external network requests a connection to the FTP server 3 located in the internal network, the FTP proxy of the firewall 1 determines whether the client 2 is an user who is permitted to connect to the internal network. According to the result of the determination, the client 2 is either permitted or not permitted to connect to the FTP server 3, and the connection is consequently completed or terminated. By doing so, the firewall 1 protects data in the internal network.

To perform this determination, the firewall 1 has many kinds of proxies that are called as an application gateway. The proxies are performed together with other protective functions, such as packet filtering. The firewall 1 performs user authentication by using a plain-text password or one-time password, and determines whether a connection is to be permitted or not by using various information of the client 2 and the FTP server 3.

A client 2 must connect to a FTP proxy being executed on the firewall 1 so that the client 2 can be provided with FTP service. After the completion of the client authentication, the client 2 is connected to the FTP server 3 of the internal network. The firewall 1 also allows an internal network user to directly connect to the server of the external network without passing the FTP proxy by using a Network Address Translation (NAT) function.

The operation of the related art protective device for internal resources will be explained as follows.

The FTP proxy provided on the firewall 1 has a single logical connection, but forms two connections. The first connection is between the client 2 and the FTP proxy, and the second connection is between the FTP proxy and the FTP server 3.

First, a client 2 located in the external network requests a connection with the FTP proxy located in the internal network in order to request a FTP service. The FTP proxy of the firewall 1 performs a user authentication function through a message exchange with an authentication in order to determine whether the requesting client 2 is an authorized user or not. The connection formed at this time is a physical connection formed between the client 2 and the FTP proxy of the firewall 1.

If, as the result of performing the user authentication function, the user authentication fails, the FTP proxy disconnects the physical connection formed between the client 2 and the FTP proxy, and then performs the function of controlling access to the FTP server.

Thus, if the rule of controlling the client's 2 access to the FTP server 3 is passed, the FTP proxy of the firewall 1 requests connection to the FTP server to thus form a physical connection between the FTP proxy and the FTP server 3. However, if the rule of controlling the client's 2 access to the FTP server 3 fails, the FTP proxy disconnects the physical connection formed between the client 2 and the FTP proxy.

The process of connecting the client 2 located in the external network and the FTP server 3 located in the internal network, as well as the activity of the client 2 during a service are recorded by the FTP proxy of the firewall 1. Recorded log information typically includes a user ID, a source IP address, a destination IP address, the date and time, and whether or not authentication succeeds, reason for disconnection, etc. Such log information can be used as connection statistics and trace data.

The above-described protective device for protecting internal resources in a general network has various problems. For example, it protects internal network resources by determining whether connection is permitted or not upon receipt of a connection request for an internal network from an external user. Accordingly, the protective function is relatively weak when an important resource is provided to an external network by an internal user.

That is, on the basis of the firewall, most internal users are authorized users, and external users are unauthorized users. Thus, considering that the firewall performs the function of monitoring internal resources is greatly loaded, the protective function of the FTP proxy of the firewall has a problem that it has no particular protective means when an internal user accesses the outside by using a FTP service.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

It is another object of the present invention to provide a protective device for internal resource protection in a network and method for operating the same that can protect internal network resources from flowing from an internal network to an external network.

It is another object of the present invention to provide a protective device for internal resource protection in a network and method for operating the same that performs user authentication and access control functions and stores transfer information for files and copies of files transmitted from the internal network to the external network, in the case that the user wants to transmit a file from the internal network to an external network by using a FTP service.

It is another object of the present invention to provide a protective device for internal resource protection in a network and method for operating the same that is capable of monitoring the flow of internal network resources to an external network in real time by storing copies of files transmitted from an internal network to an external network and recording transfer information and at the same time informing an operator of the same in real time.

To achieve at least the above objects in whole or in parts, there is provided a protective device for internal resource protection in a network according to the present invention, which includes a firewall for selectively performing a disconnection function for a request for accessing to an internal network from an external network; a FTP proxy for performing an authentication function for a request for accessing from an internal network to an external network and recording copies of data transmitted to the external network and log information related to the transmission of the above data by an authenticated user; a file system for storing data transmitted from an internal network to an external network by types of data according to the control of the FTP proxy; a database for storing log information related to the transmission of data according to the control of the FTP proxy; and a client for requesting a FTP server of the external network to send a FTP service if the authentication succeeds by the FTP proxy.

To further achieve at least the above objects in whole or in parts, there is provided a method for operating a protective device for internal resource protection in a network according to the present invention, which includes the steps of if a request for accessing to an external network from an internal user of a local network (internal network) in which a firewall is built, judging whether an access request can be permitted or not; if the access request can be permitted, connecting to a server located in an external network; and receiving a service command from the user who is permitted to access; if the received service command is a command for designating the type of data, storing the designated type of data; and if the received service command is a command for requesting a data transmission, transmitting the data transmitted from the user and recording the transmission and reception of services.

To further achieve at least the above objects in whole or in parts, there is provided a method for operating a protective device for internal resource protection in a network according to the present invention, which includes the steps of giving an internal user of a local network (internal network) in which a firewall is built a proper ID and host, performing authentication and access control for a request for accessing to an external network from the internal user, and if an access to the external network is permitted, connecting to a server of the external network; receiving a service command from the user, and if the received service command is a command for requesting data transmission, transmitting file data transmitted from the user to the server, storing copies of the transmitted file data and log information, and transmitting the log information to an operator.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating one example of a related art protective device for a general network;

FIG. 2 is a block diagram illustrating the construction of a protective device for internal resource protection in a network according to a preferred embodiment of the present invention;

FIG. 3 is a sequential view illustrating a protective method for internal resource protection in a network according to the preferred embodiment of the present invention;

FIG. 4 is a sequential view illustrating a method for storing files and log information of FIG. 3; and

FIG. 5 is a view illustrating a message format of log information of FIG. 4.

### DETAILED DESCRIPTION OF PREFERRED EMBODIMENTS

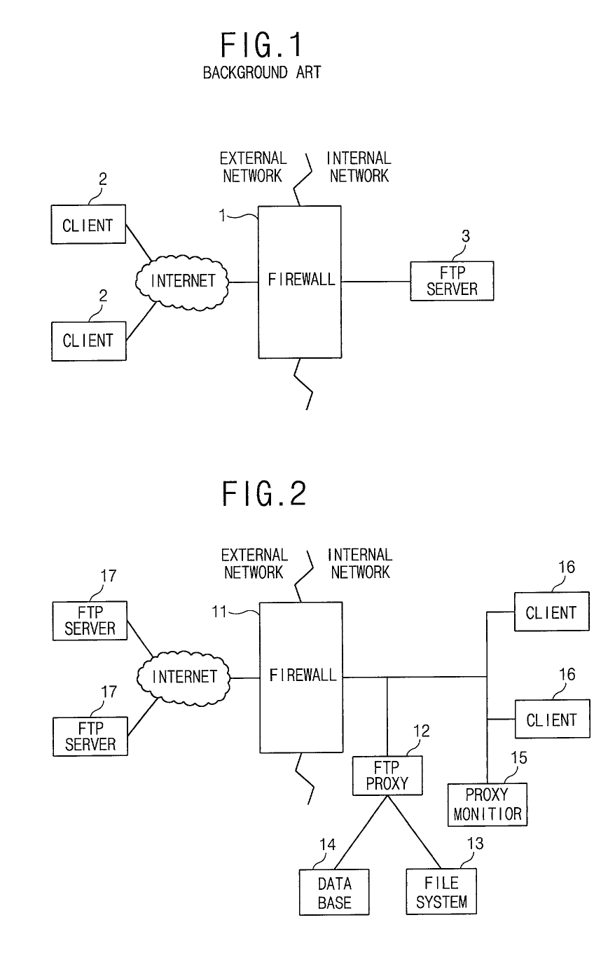

FIG. 2 is a block diagram illustrating the construction of a protective device for internal resource protection in a network according to a preferred embodiment of the present invention. As shown in FIG. 2, the protective device preferably includes a firewall 11 for selectively performing a disconnection function for an access request to an internal network from an external network, and a FTP proxy 12 for performing an authentication function for an access request from an internal network to an external network and recording copies of data transmitted to the external network and log information related to the transmission of the above data by an authenticated user. The device further includes a file system 13 for storing data transmitted from an internal network to an external network by types of data according to the control of the FTP proxy 12, a database 14 for storing log information related to the transmission of data according to the control of the FTP proxy 12, and a proxy monitor 15 for displaying the log information outputted from the FTP proxy 12 so that an operator can view it. A FTP server 17 is provided for performing a FTP service according to the request of the client 16 located in the internal network and a client 16 is shown for requesting a FTP server of the external network to send a FTP service if the authentication succeeds by the FTP proxy 12.

The thusly constructed device of the preferred embodiment can be implemented by a network having a firewall. The control of access to the internal network from an external network is performed by the firewall, and the control of access to an external network from the internal network, including the monitoring and tracing of data transmission, is performed by the FTP proxy. In other words, in the protective device of the present invention, files and transmission information transmitted upon file transmission from an internal network to an external network can be logged by the FTP proxy, and a system operator can monitor the activity of the users of the internal network.

The firewall 11 is preferably disposed between an internal network and an external network to protect resources of the internal network from an invader of the external network. The FTP proxy 12 exists in the internal network to log information regarding file transmission to the external network. The FTP client 16 existing in the internal network can connect to the FTP server 17 of the external network only through the FTP proxy 12.

The connection between the FTP client 16 and the FTP server 17 is a two stage connection. It includes a connection between the FTP client 16 and the FTP proxy 12, and a connection between the FTP proxy 12 and the FTP server 17. A control connection and a data connection exist in this connection between the FTP client 16 and the FTP server 17. FTP commands and FTP replies are communicated with each other by the control connection, and files and directories are transmitted by the data connection. The FTP command preferably has a 3 or 4-byte character format, and some FTP command has arbitrary factors. The FTP replies are expressed in a 3-digit PSCII format followed by an additional message.

The operation of the thusly constructed protective device according to the preferred embodiment of the present invention will be described as follows.

The FTP proxy 12 for internal network protection performs various functions. These functions include an authentication function for confirmation of a FTP service user, an access control function for checking whether each user has connected from a permitted host, a logging function for logging files transmitted to an external network; an audit function for storing service information in the database 14, and a monitoring function for informing the system operator of the service information.

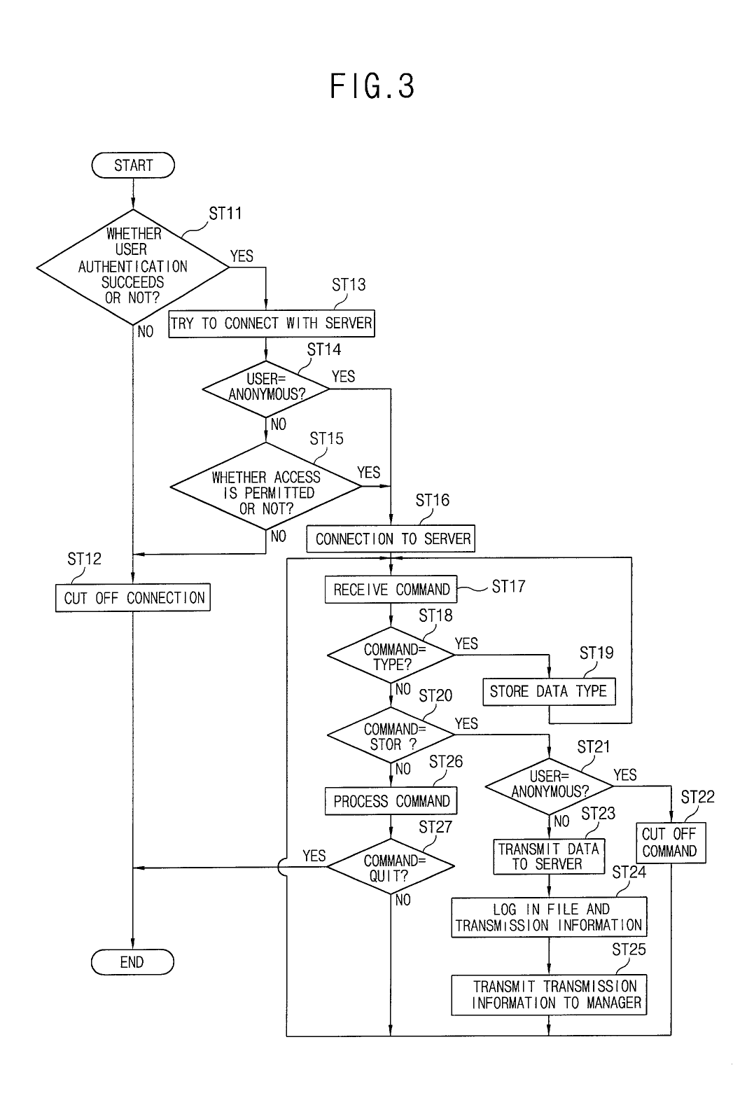

As illustrated in FIG. 3, if the client 16 of the internal network tries to connect to the FTP proxy 12 to request FTP service from the FTP server 17 located in the external network, the FTP proxy 12 performs the authentication function by checking the ID and password of the user requesting the FTP service (ST11). If the authentication of the user requesting the FTP service fails, the FTP proxy 12 cuts off the connection (ST12).

If, however, the authentication of the user requesting the FTP service succeeds, the FTP proxy 12 tries to connect with the FTP server (ST 13). Additionally, the FTP proxy 12 checks to determine if the user ID is “Anonymous” (ST14).

If the user ID is “Anonymous,” the FTP proxy 12 is permitted to connect with the FTP server 17 without any particular access control operation (ST16). Thus, a physical connection between the client 16 and the FTP server 17 of the external network is established. However, if the user ID is not “Anonymous,” but is instead a specific user account (ID), the access control function for the external network is performed by determining whether an access control is generated from a host (client) permitted for the specific ID.

In other words, the FTP proxy 12 compares the IP address of the host (client) requesting the FTP service with the IP address of the host registered in the database 14. If the IP address of the host requesting the FTP service is identical to the IP address of the registered host, the FTP proxy 12 gives all user's rights of the FTP service to the host requesting the FTP service (ST15). The user is then connected to the FTP server 17 (ST16). However, if the IP address of the host requesting the FTP service is not identical to the IP address of the registered host, the FTP proxy 12 cuts off the connection (ST12).

Therefore, even in case of an authenticated user having a proper ID, if that user tries to connect through a host other than the host (client) permitted for the corresponding user ID, the FTP proxy 12 disconnects with the FTP server 17. The FTP proxy 12 controls such that the registered host can try to connect to all user IDs except for “Anonymous” by performing an access control function. Therefore, a plurality of users are prevented from performing a FTP service request through a single authorized account.

The registration of a host for access control execution is achieved by specifying a host capable of connecting to an external network using a user ID upon registration of the user ID and registering the same in the database 14.

As the result of step ST16, if the client 16 and the FTP server 17 are connected, the client 16 transmits FTP command to the FTP server 17 by the control connection. The FTP proxy 12 receives FTP commands transmitted from the client 16 over the control connection (ST17), and checks the type of command.

If a received command is TYPE, which is used to designate a data type (ST18), the FTP proxy 12 stores data type information designated by the client 16 in a memory (ST19).

If the received command is “STOR,” which is used for transmitting files to the FTP server 17 in the external network (ST20), the FTP proxy 12 determines whether the user ID is “Anonymous” (ST21). If the user ID is “Anonymous,” the FTP proxy 12 prevents the command from being transmitted to the FTP server 17 (ST22). Thusly, if the user ID is “Anonymous” in the internal network, connection is permitted without any other access control operation. However, the client 16 who requests the FTP service using “Anonymous” ID cannot use commands such as “put” or “input” for file transmission to the FTP server 17. Consequently, the user who uses “Anonymous” is permitted to use only commands other than the commands for file transmission to an external network.

However, if the user ID is not “Anonymous,” the FTP proxy 12 transmits the “STOR” command to the FTP server 17 using the control connection for the purpose of processing this command (ST23). The data transmission is achieved using the data connection. The FTP proxy 12 stores copies of data having the format of files transmitted to the FTP server 17 in the file system 13. In addition, when the transmission of data files to the FTP server 17 is completed, the FTP proxy 12 records transmission information in the database 14 (ST24). At the same time, the FTP proxy 12 transmits transmission information to the proxy monitor 15 (ST25).

If the FTP command received from the client 16 is QUIT command, i.e., a connection completion command, the FTP proxy 12 completes the connection between the FTP server 17 and the client 16 (ST27).

However, if the FTP command received from the client 16 is another command other than TYPE, STOR, or QUIT, the FTP proxy transmits that command to the FTP server 17 (ST26).

The functions of steps ST 24 and ST25, i.e., the function of logging on file data and transmission information transmitted to an external network and the function of monitoring transmission information in real time, will now be described in further detail.

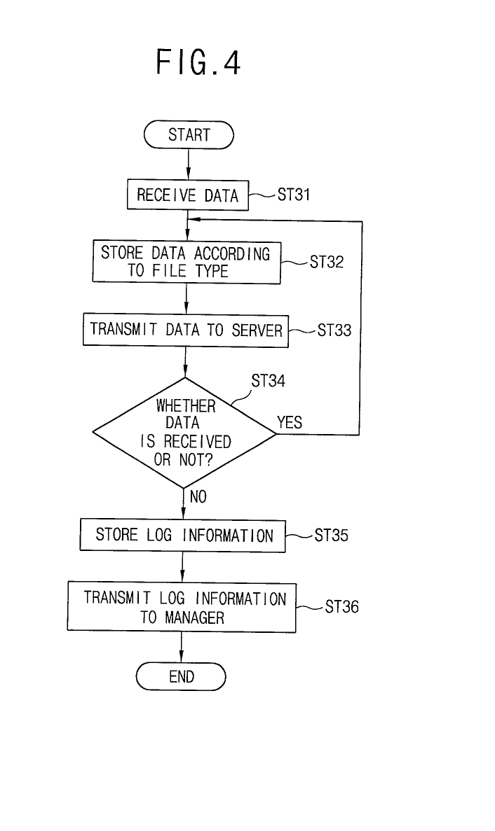

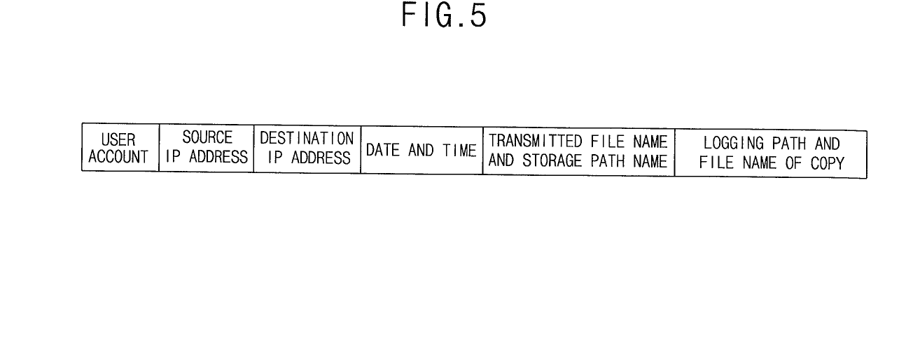

As illustrated in FIG. 4, the FTP proxy 12 receives file data (ST31). The file data is data that the FTP client 16 is about to transmit to the FTP server 17 existing in the external network using a data connection. Next, the FTP proxy 12 identifies the file data according to the data type designated by the client 16 to thus store the same in the file system 13 (ST32). The file data stored in the file system 13 consists of copies of file data transmitted to the FTP server 17.

The data type of the file data stored in the file system 13 includes ASCII type, EBCDIC (Extended Binary Coded Decimal Interchange Code) type, and Image type. The types of data are identified before storage in the file system 13 to make the maintenance and management of each file easier.

If the client 16 designates a data type by control connection, the FTP proxy 12 stores filed data in the file system 13 in the form of a designated data type. In addition, if it is impossible to identify the data type of the file data to be stored in the file system 13, or if the data type of the file data is a type other than ASCII, EBCDIC, or Image type, the FTP proxy 12 identifies the file data as the image type, and stores it in the file system 13.

After storing copies of filed data in the file system 13, the FTP proxy 12 transmits the file data to the FTP server 17 (ST33). Then, the FTP proxy 12 determines whether more file data has been received from the client 16 (ST34). The FTP proxy 12 repeats steps ST31-ST34 if there is more file data received therefrom, i.e., there remains file data to be transmitted.

If, however, there is no additional filed data received, i.e., all the file data to be transmitted to the FTP server 17 has been transmitted, the FTP proxy 12 records transmission information of file data transmitted to the FTP server 17 in the database 14 (ST35). At the same time, the transmission information is transmitted to the proxy monitor 15 by using a UDP (User Data Protocol). In other words, the FTP proxy 12 transmits the transmission information to the IP address of the proxy monitor 15 stored in the database 14.

The proxy monitor 15 preferably receives all file transmission information generated upon the execution of a monitoring program in real time, and displays the received transmission information so that an operator can recognize it. The condition of the FTP service between the client of the internal network and the FTP server of the external network can thus be audited by an operator.

FIG. 5 is a diagram illustrating the message format for the transmission information. The message representing the transmission information preferably includes a user ID for performing file data transmission, an IP address (source IP address) of the client 13 being used by the user, and an IP address (destination IP address) of the FTP server that receives the corresponding file data. The message further includes the date and time of the file data transmission, a file name and absolute path of the file data to be stored in the FTP server, and a file name and absolute path of the file data logged on the FTP proxy.

When copies of file data are stored in the file system 13, it is possible that the file name could be repeated. However, the FTP proxy 12 prevents a stored copy of a file from being overwritten and lost by attaching a series of numbers to the subsequently stored file name in a time order to thus form a unique file name.

As described above, the protective device for internal resource protection in a network and method for operating the same according to the preferred embodiment has many advantages. For example, when connecting to the FTP server of the external network from the internal network, even an authenticated user is permitted to use a FTP service only at a designated host by performing user authentication and access control functions. Consequently the right to use a FTP service for an internal network user is intensified.

Additionally, when transmitting a file from an internal network to an external network by using a FTP service, internal network resources passing from the internal network to the external network can be monitored and traced in real time by storing the copy of the transmitted file and the transmission information for the file and informing the operator of the transmission information, thus protecting the internal network resources.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A protective device for internal resource protection in a network, comprising:
a firewall between an internal network and an external network, to selectively perform a disconnection function for an access request to the internal network from the external network;
a FTP proxy to perform an authentication function for an access request from the internal network to the external network and to record copies of data transmitted to the external network and log information related to the transmission of data by an authenticated user;
a file system to store data transmitted from the internal network to the external network according to the control of the FTP proxy; and
a database to store log information related to the transmission of data according to the control of the FTP proxy.

2. The device of claim 1, further comprising a proxy monitor configured to display the log information outputted from the FTP proxy.

3. The device of claim 1, wherein a client can connect to a FTP server of the external network through the FTP proxy.

4. The device of claim 1, wherein the log information comprises a file name and absolute path of the file data to be stored in the FTP server, and a file name and absolute path of the file data logged on the FTP proxy.

5. A method for protecting internal resources in a network, comprising:
determining whether an access request for accessing an external network from an internal user of an internal network is permitted or not;
connecting to a server located in the external network if the access request is permitted;
receiving a service command from the internal user;
if the received service command is a command designating a type of data, storing the designated type of data; and
if the received service command is a command requesting data transmission, transmitting data from the internal user and recording the transmission and reception of services.

6. The method of claim 5, wherein the step of determining whether an access request is permitted comprises:
determining whether an ID transmitted from the internal user is a registered ID or not; and
controlling access by determining whether a host that has transmitted the access request is a registered host or not, if the ID of the internal user is a registered ID.

7. The method of claim 6, wherein the access control step comprises:
reading host information corresponding to the registered ID from an internal database using the registered ID;
determining whether the host information read from the database and the host that has transmitted the access request are identical or not;
permitting access to the external network if the two hosts are identical.

8. The method of claim 5, wherein access control is not performed if the ID transmitted from the internal user is “Anonymous”

9. The method of claim 5, wherein the step of transmitting data comprises:
checking an ID of the internal user if the received service command is a command requesting data transmission;
if the user ID is “Anonymous,” interrupting the transmission of the received service command to the external network; and
if the user ID is a registered ID other than “Anonymous,” transmitting the received service command to the external network and transmitting the data received from the internal user to the external network.

10. The method of claim 5, wherein recording the transmission and reception of services comprises:
receiving file data to be transmitted from the internal user to the external network;
identifying the file data according to its data type to store the file data in the file system; and
recording log information on the transmission of file data in a database.

11. The method of claim 10, wherein the filed data can be identified by the user as a designated data type or can be identified as a default data type.

12. The method of claim 10, wherein the log information is recorded in the database when all data to be transmitted from the internal user to the external network is transmitted.

13. The method of claim 10, wherein the log information comprises a file name and absolute path of the file data to be stored in the FTP server, and a file name and absolute path of the file data logged on the FTP proxy

14. A method for protecting internal resources in a network, comprising:
giving an internal user of a local network in which a firewall is built a proper ID and host information;
performing authentication and access control upon receiving a request for access to an external network from the internal user;
connecting to a server of the external network if an access to the external network is permitted; and
receiving a service command from the internal user, and if the service command is a request for data transmission, transmitting file data transmitted from the internal user to the server and storing copies of the transmitted file data and log information in a database.

15. The method of claim 14, wherein the authentication and access control comprises:
determining whether the ID transmitted from the internal user is a registered ID;
if the ID is registered, reading host information corresponding to the registered ID from the database;
determining whether the host information read from the database and the host who has transmitted the access request are identical; and
permitting access to the external network if the two hosts are identical.

16. The method of claim 14, wherein storing copies of the transmitted file data and log information comprises:
receiving file data to be transmitted from the user to the external network;
identifying the file data according to a data type to thus store the file data in the file system; and
recording log information regarding the transmission of file data in a database.

17. The method of claim 16, wherein the log information comprises a user ID for performing file data transmission, a source IP address of the client being used by the internal user, a destination IP address of the FTP server that receives the file data, a date and time of file data transmission, a file name and absolute path of the file data to be stored in the FTP server, and a file name and absolute path of the file data logged on the FTP proxy.

18. The device of claim 1, wherein the file system stores data according to a type of the data.

19. The device of claim 18, wherein the type of data is at least one of ASCII, EBCDIC, and Image.

20. The device of claim 1, further comprising a client, coupled to the firewall and to the FTP proxy, to request FTP service from the external network if the FTP proxy successfully authenticates the client.

21. The method of claim 10, further comprising outputting the log information in a form recognizable to a system operator.

22. The method of claim 16, further comprising outputting the log information in a form recognizable by a system operator.
